(19) United States
(12) Patent Application Publication
(10) Pub. No.: US 2026/0042058 A1
(43) Pub. Date: Feb. 12, 2026

(54) METHOD AND SYSTEM FOR TREATING SULFUR DIOXIDE CONTAINING STREAM BY CATALYTIC OXIDATION AND ACID AQUEOUS ABSORPTION

(71) Applicant: Saudi Arabian Oil Company, Dhahran (SA)

(72) Inventors: Guillaume Robert Jean-Francois Raynel, Dhahran (SA); Sebastien A. Duval, Dhahran (SA); Feras Hamad, Dhahran (SA); Khadijah Ghazi Alshadly, Dhahran (SA); Faisal Ibrahim Jassim, Al Jubail (SA)

(21) Appl. No.: 18/798,728

(22) Filed: Aug. 8, 2024

(51) Int. Cl. B01D 53/75; B01D 53/34; B01D 53/78; B01D 53/86; B01J 23/22; B01J 23/92; B01J 38/12; C02F 1/44; C02F 101/10; C02F 103/18

(52) U.S. Cl. CPC B01D 53/75; B01D 53/343; B01D 53/78; B01D 53/8609; B01J 23/22; B01J 23/92; B01J 38/12; C02F 1/441; B01D 2255/20723; B01D 2257/302; C02F 2101/101; C02F 2103/18; C02F 2209/06

(57) ABSTRACT

Provided herein are methods and systems for treating a sulfur dioxide-containing gaseous stream. The method includes combusting a tail gas in an excess of oxygen gas to yield a thermal oxidizer effluent containing sulfur dioxide and oxygen. The thermal oxidizer effluent is introduced to an oxidative catalytic converter to convert sulfur dioxide to sulfur trioxide, thereby forming an oxidized gas stream. The oxidized gas stream is routed to a quench tower and contacted with a dilute aqueous acid quench stream to yield sulfurous acid, hydrated sulfur dioxide, or both. The sulfurous acid or hydrated sulfur dioxide is oxidized with the excess of oxygen from the thermal oxidizer effluent to yield sulfuric acid.

### TECHNICAL FIELD

The present disclosure relates to methods and systems for removing sulfur-containing compounds from a tail gas of a sulfur recovery plant or a flue gas, more particularly, to methods and systems for treating a sulfur dioxide (SO₂)-containing gaseous stream.

### BACKGROUND

Due to the implementation of stringent environmental regulations, the removal of sulfur-containing compounds from emissions is becoming increasingly important. In some instances, a minimum sulfur recovery efficiency of 99.9% is required. One popular method for sulfur recovery is the Shell Claus Off Gas Treatment (SCOT) process, where sulfur compounds are converted to hydrogen sulfide (H₂S) and then scrubbed by amines. However, this process is costly due to the use of proprietary amines and additional treatment steps. Consequently, there is a need to develop cost-effective and sustainable tail gas treatment methods and systems.

### SUMMARY

In an exemplary embodiment, a method for treating a sulfur dioxide (SO₂) containing gaseous stream is provided. The method includes introducing a thermal oxidizer effluent in a gaseous form containing oxygen (O₂) and SO₂ into an oxidative catalytic converter including a plurality of vertically positioned catalytic beds. In some embodiments, each of the plurality of vertically positioned catalytic beds includes an alkali metal-promoted catalyst. The method also includes passing the thermal oxidizer effluent through the oxidative catalytic converter to contact the thermal oxidizer effluent with the alkali metal-promoted catalyst, thereby oxidizing at least a portion of the SO₂ to sulfur trioxide (SO₃) with the O₂ from the thermal oxidizer effluent and producing a spent catalyst and an oxidized gas stream leaving the oxidative catalytic converter; cooling the oxidized gas stream in a waste heat recovery system to generate a cooled exit stream; introducing the cooled exit stream into a quench tower including one or more packing zones;

contacting the cooled exit stream with a diluted aqueous acid quench stream in the quench tower to dissolve the SO₃ and the rest of the portion of the SO₂ in the diluted aqueous acid quench stream, thereby generating sulfurous acid (H₂SO₃), hydrated sulfur dioxide, and sulfuric acid (H₂SO₄); and oxidizing the H₂SO₃ and the hydrated sulfur dioxide with the O₂ from the thermal oxidizer effluent in the one or more packing zones, thereby generating a diluted aqueous acid product stream containing H₂SO₄ leaving the quench tower.

In some embodiments, the method further includes combusting a fluid composition in a thermal oxidizer to generate the thermal oxidizer effluent containing the O₂ and SO₂. In some embodiments, the fluid composition contains a combustible gas, an oxygen-containing oxidant gas, and a tail gas containing one or more sulfur-containing compounds.

In some embodiments, the oxygen-containing oxidant gas contains a number of moles of oxygen exceeding the number of moles of oxygen required to fully combust the sulfur-containing compounds and the combustible gas.

In some embodiments, the one or more sulfur-containing compounds are selected from the group consisting of hydrogen sulfide (H₂S), SO₂, sulfur vapor, carbonyl sulfide (COS), and carbon disulfide (CS₂).

In some embodiments, the combustible gas is selected from the group consisting of methane, propane, butane, ethylene, propylene, acetylene, hydrogen, natural gas, ethane, methanol, ethanol, and mixtures thereof.

In some embodiments, the O₂ is present in the thermal oxidizer effluent in an amount of about 2 to about 30 vol. % by a total volume of the thermal oxidizer effluent.

In some embodiments, the alkali metal-promoted catalyst is an alkali metal-promoted vanadium catalyst. In some embodiments, the alkali metal is selected from the group consisting of cesium, potassium, rubidium, lithium, sodium, and mixtures thereof.

In some embodiments, the alkali metal-promoted catalyst is regenerated in-situ in the oxidative catalytic converter by reacting the spent catalyst with the O₂ from the thermal oxidizer effluent during the passing.

In some embodiments, the H₂SO₄ is present in the diluted aqueous acid product stream in an amount of about 0.1 and about 10 wt. % by a total weight of the diluted aqueous acid product stream.

In some embodiments, the quench tower is in the form of a cylindrical reactor including an upper section, a lower section, and two or more packing zones evenly distributed within the upper section and lower section of the quench tower. In some embodiments, the two or more packing zones are separated by a perforated plate configured to allow gas molecules to pass through and redistribute water within packing zones of the lower section.

In some embodiments, the upper section and the lower section are connected via the perforated plate.

In some embodiments, the method further includes cooling the diluted aqueous acid product stream in a cooler to generate a cooled diluted aqueous acid product stream containing H₂SO₄; and introducing the cooled diluted aqueous acid product stream containing H₂SO₄ into a buffer tank. In some embodiments, the buffer tank is in fluid communication with the quench tower via the diluted aqueous acid quench stream. In some embodiments, the buffer tank is in fluid communication with a water treatment unit via a diluted aqueous acid buffer stream.

In some embodiments, the water treatment unit generates a permeate that is substantially water and a H₂SO₄-containing retentate having a H₂SO₄ concentration of about 3 to about 98 wt. % of the H₂SO₄-containing retentate.

In some embodiments, the method further includes introducing the permeate of the water treatment unit to the buffer tank.

In an exemplary embodiment, a system for sulfur dioxide (SO₂) removal is provided. The system includes a thermal oxidizer configured to receive and combust a fluid composition containing a combustible gas, an oxygen (O₂)-containing oxidant gas, and a tail gas to generate a thermal oxidizer effluent containing sulfur dioxide (SO₂) and O₂; an oxidative catalytic converter coupled to the thermal oxidizer and configured to oxidize at least a portion of the SO₂ to SO₃ with the O₂ from the thermal oxidizer effluent and produce a spent catalyst and an oxidized gas stream leaving the oxidative catalytic converter; a waste heat recovery system coupled to the oxidative catalytic converter and configured to cool the oxidized gas stream to generate a cooled exit stream; a quench tower including one or more packing zones coupled to the waste heat recovery system and configured to receive the cooled exit stream, and contact the cooled exit stream with a diluted aqueous acid quench stream to dissolve the SO₃ and the rest portion of the SO₂ in the diluted aqueous acid quench stream to generate sulfurous acid (H₂SO₃), hydrated sulfur dioxide, and sulfuric acid (H₂SO₄), and to oxidize the H₂SO₃ and the hydrated sulfur dioxide with the O₂ from the thermal oxidizer effluent to generate a diluted aqueous acid product stream containing H₂SO₄ leaving the quench tower; a cooler coupled to the quench tower and configured to receive and cool the diluted aqueous acid product stream to generate a cooled diluted aqueous acid product stream; a first buffer tank coupled to the cooler and configured to receive the cooled diluted aqueous acid product stream and generate a diluted aqueous acid buffer stream containing H₂SO₄; and a water treatment unit coupled to the buffer tank and configured to receive the diluted aqueous acid buffer stream containing H₂SO₄ and generate a permeate and a H₂SO₄-containing retentate.

In some embodiments, the buffer tank further includes a vent. In some embodiments, the vent is connected to a clean water stream or a water trap.

In some embodiments, the water treatment unit is selected from the group consisting of a reverse osmosis (RO) membrane unit, an electrodialysis unit, a distillation unit, and combinations thereof.

In some embodiments, the water treatment unit is a RO membrane unit. In some embodiments, the RO membrane unit yields a permeate that is substantially water and a retentate containing about 3 to about 98 wt. % of H₂SO₄.

In some embodiments, the thermal oxidizer effluent is introduced into the oxidative catalytic converter at a temperature of about 400° C.

In some embodiments, the waste heat recovery system is configured to cool the oxidized gas stream to a temperature of about 105° C.

In some embodiments, the diluted aqueous acid quench stream is introduced into the quench tower at a temperature of about 40 to about 65° C.

In some embodiments, the diluted aqueous acid product stream contains about 0.1 to about 10 wt. % of H₂SO₄.

In some embodiments, the quench tower is in the form of a cylindrical reactor including an upper section, a lower section, and two or more packing zones evenly distributed in the upper section and lower section of the quench tower. In some embodiments, the two or more packing zones are separated by a perforated plate configured to allow gas molecules to pass through and redistribute water within packing zones of the lower section.

In some embodiments, the system further includes a second buffer tank coupled between the quench tower and the water treatment unit. In some embodiments, the second buffer tank is configured to bypass the water treatment unit and receive the diluted aqueous acid buffer stream from the first buffer tank or receive the permeate from the water treatment unit, and configured to flow the diluted aqueous acid buffer stream to the upper section of the quench tower.

In some embodiments, the quench tower is in the form of a cylindrical reactor including an upper section, a lower section, and two or more packing zones evenly distributed in the upper section and lower section of the quench tower. In some embodiments, the two or more packing zones are separated by a plate. In some embodiments, the plate includes a plurality of bubble caps, and is configured to allow gas molecules to pass through the plate and collect recovered water. In some embodiments, the quench tower further includes a pH monitor configured to monitor the pH of the fresh water stream.

In some embodiments, the system further includes a second buffer tank coupled between the quench tower, the water treatment unit, and the first buffer bank. In some embodiments, the quench tower second buffer tank is configured to bypass the water treatment unit and receive the diluted aqueous acid buffer stream from the first buffer tank, or receive the permeate from the water treatment unit, configured to flow the diluted aqueous acid buffer stream to the upper section of the quench tower, and configured to receive the fresh water stream from the quench tower via a valve when the pH of the recovered water is below 0.5.

### BRIEF DESCRIPTION OF THE DRAWINGS

FIG. 1 is a schematic diagram depicting hydration reactions of sulfur dioxide (SO₂) and sulfur trioxide (SO₃), according to certain embodiments of the present disclosure.

FIG. 2 is an example schematic of a system 100 for removing SO₂ from a gaseous stream, according to certain embodiments of the present disclosure.

FIG. 3 is an example schematic of a system 200 for removing SO₂ from a gaseous stream, according to certain embodiments of the present disclosure.

FIG. 4 is an example schematic of a system 300 for removing SO₂ from a gaseous stream, according to certain embodiments of the present disclosure.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “room temperature” and “ambient temperature” refer to a temperature in a range of 25 degrees Celsius (° C.)±3° C.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the term “volume percent” (vol %) refers to a volume fraction or a volume ratio of a substance to the total volume of the mixture or composition.

As used herein, the term “substantially” refers to a majority of, or mostly, as in at least about 50%, such as about 60%, about 70%, about 80%, about 90%, about 95%, about 96%, about 97%, about 98%, about 99%, about 99.5%, about 99.9%, about 99.99%, or at least about 99.999% or more.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In view of the foregoing, one objective of the present disclosure is to provide a method for treating a sulfur dioxide (SO₂)-containing gaseous stream. A second objective of the present disclosure is to provide a one-stage quench tower-containing system for SO₂ removal. A third objective of the present disclosure is to provide a multi-stage quench tower-containing system for SO₂ removal. A fourth objective of the present disclosure is to provide a polishing-stage quench tower-containing system for SO₂ removal.

Provided in this disclosure are methods and systems for removing sulfur compounds, such as SO₂, from a gaseous stream. In some implementations, the gaseous stream is a tail gas from a sulfur recovery plant, or a flue gas from a H₂S-containing fuel gas. The techniques described in this disclosure can be implemented to more efficiently treat the sulfur compound-containing gaseous stream compared to currently available methods. Compared to currently available methods, the techniques described here offer higher percentage of sulfur recovery and are comparatively less expensive.

A Claus process is a method of converting the hydrogen sulfide extracted from natural gas, crude oil, or other industrial fluids or gases. The Claus process consists of two steps:

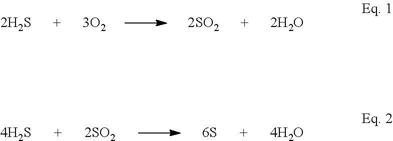

The tail gas that can be treated by the methods of the present disclosure can contain one or more compounds including, but not limited to, sulfur dioxide (SO₂), hydrogen sulfide (H₂S), carbon dioxide (CO₂), nitrogen gas (N₂), hydrogen gas (H₂), water (H₂O), carbon monoxide (CO), carbonyl sulfide (COS), traces of carbon sulfide (CS₂), and allotropes of sulfur (S₆, S₇, and S₈).

In some implementations, sulfur-containing compounds are from the tail gas of a Claus process. In further implementations, the sulfur-containing compounds are from a flue gas of a H₂S-containing fuel gas. In some embodiments, the H₂S-containing fuel gas has a H₂S content of about 500 to about 2000 parts per million (ppm), such as about 600 to about 1700 ppm, about 700 to about 1400 ppm, about 800 to about 1100 ppm, or about 1000 ppm. The methods and systems of the present disclosure can remove a multitude of different sulfur-containing compounds from a tail gas or a flue gas after combustion of crude oil and coal, or the removal of and processing of crude oil and coal before combustion. The methods and systems convert the sulfur-containing compounds to SO₂, contacting the SO₂ with an aqueous solution dissolve the SO₂, and oxidizing the hydrated SO₂ to sulfuric acid. The produced sulfuric acid can then be monetized or used in subsequent processes. For example, the produced sulfuric acid can be used in dyes, paper, glass, astringents, batteries, drain cleaners, metal processing, and fertilizer manufacture.

In some implementations, the tail gas of a Claus process is combusted with a fuel gas, for example, CH₄ or C₂H₆, in a thermal oxidizer. The combustion occurs with an excess of oxygen gas. An excess of oxygen gas includes a number of moles of oxygen exceeding the number of moles of oxygen required to fully combust the sulfur-containing compounds. In some implementations, the oxygen gas is supplied by ambient air. The thermal oxidizer yields an exhaust gas, e.g., a thermal oxidizer effluent, that contains about 1 to about 30 vol. % of O₂, such as about 1.5 to about 25 vol. %, about 2 to about 20 vol. %, about 2.5 to about 15 vol. %, about 3 to about 10 vol. %, or about 3.5 to about 7 vol. % of O₂, along with CO, SO₂, CO₂, N₂, H₂O, and traces of SO₃. This effluent is further introduced into an oxidative catalytic converter to react SO₂ with O₂ to form SO₃, thereby generating an oxidized gas stream containing SO₃. This oxidized gas stream is cooled by contacting with a chilled acidic water. This contact also condenses water vapor in the oxidized gas stream. Further, SO₂ and SO₃ from the oxidative catalytic converter dissolve and hydrate in water, and, in the aqueous phase, react with the excess of oxygen present in the thermal oxidizer effluent to yield to a mixture of sulfurous acid (H₂SO₃) and sulfuric acid (H₂SO₄). The oxidation of SO₂ is thermodynamically allowed in water. The H₂SO₃ and the hydrated sulfur dioxide are further oxidized in a quench tower by contacting with a diluted aqueous acid quench stream, thereby yielding a diluted aqueous acid product stream containing substantially H₂SO₄. The diluted aqueous acid product stream containing substantially H₂SO₄ is cooled further and split into two streams. A first stream is sent back into the quench tower as the diluted aqueous acid quench stream. A second stream is processed to yield a weakly acidic water and a concentrated sulfurous/sulfuric acid stream. The weakly acidic water can be sent to an evaporation pond or reused. The concentrated sulfurous/sulfuric acid stream can be monetized or sent to a sulfur recovery unit (SRU) to enrich a Claus furnace in oxygen. In some implementations, this can help a plant, business, commercial enterprise, or other emissions-producing entity achieve sulfur recovery or emission targets.

Advantageously, this approach can be used to remove a wide variety of sulfur-containing compounds in the tail gas or in the flue gas by transforming sulfur-containing compounds into sulfur dioxide via combustion, followed by subsequent transformation into sulfuric acid in a quench tower via absorption and oxidation with an excess of oxygen.

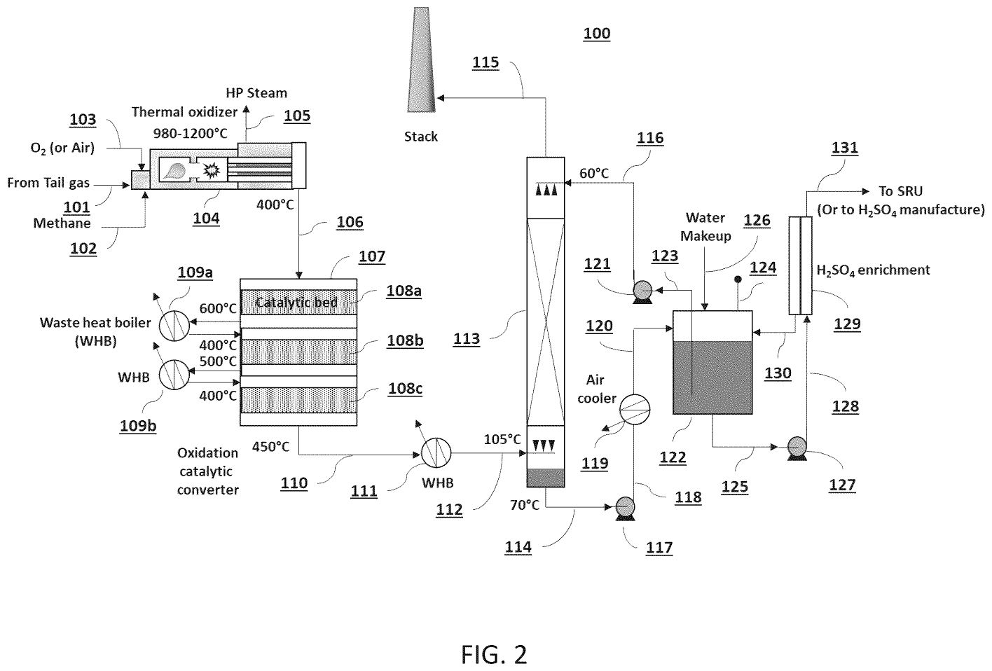

FIG. 2 is an example schematic of a system 100 for removing SO₂ from a gaseous stream. The system 100 contains a one-stage quench tower 113 for the SO₂ removal from a thermal oxidizer effluent 106. The thermal oxidizer effluent 106 is the result of the complete combustion of hydrogen sulfide and other sulfur-containing compounds, for example, carbonyl sulfide (COS) and carbon disulfide (CS₂), in a thermal oxidizer 104. The thermal oxidizer effluent 106 contains at least sulfur dioxide (SO₂) and oxygen (O₂). In further embodiments, the thermal oxidizer effluent 106 also contains sulfur trioxide (SO₃), water vapor (H₂O), carbon dioxide (CO₂), and nitrogen (N₂). In some embodiments, a tail gas containing carbon monoxide (CO), one or more sulfur-containing compounds, H₂O, N₂, and CO₂ is introduced into the thermal oxidizer 104. In some embodiments, the one or more sulfur-containing compounds are selected from the group consisting of hydrogen sulfide (H₂S), sulfur dioxide (SO₂), sulfur vapor, carbonyl sulfide (COS), and carbon disulfide (CS₂). In further embodiments, the one or more sulfur-containing compounds are H₂S and SO₂. In some embodiments, the H₂S and SO₂ are present in the tail gas at a ratio of about 8:1 to about 1:4, such as about 6:1 to about 1:2, about 4:1 to about 1:1, or about 2:1. In further embodiments, the H₂S and SO₂ are present in the tail gas at a ratio of about 2:1.

The tail gas 101 is sent to the thermal oxidizer 104 in the presence of a combustible gas 102 and an oxidant gas 103. In some embodiments, the combustible gas is selected from the group consisting of methane, propane, butane, ethylene, propylene, acetylene, hydrogen, natural gas, ethane, methanol, ethanol, and mixtures thereof. In further embodiments, the combustible gas is methane. In some embodiments, the oxidant gas 103 is an oxygen-containing oxidant gas. In some embodiments, the oxygen is present in the oxidant gas 103 in an amount of about 10 to about 99.99 wt. %, such as about 30 to about 99.99 wt. %, about 50 to about 99.99 wt. %, about 70 to about 99.99 wt. %, about 90 to about 99.99 wt. %, or about 99.99 wt. % based on a total weight of the oxidant gas 103. In some embodiments, the oxidant gas 103 originates from the air or an oxygen-enriched source. The combustion reaction that occurs in the thermal oxidizer 104 transforms a fluid composition containing the tail gas 101, the combustible gas 102, and the oxidant gas 103, into the thermal oxidizer effluent 106. The thermal oxidizer effluent 106 includes, but is not limited to, H₂O, CO₂, SO₂, and an excess of O₂. In some embodiments, the thermal oxidizer effluent 106 further includes traces of SO₃ and N₂. In some embodiments, the thermal oxidizer effluent 106 contains about 1 to about 30 vol. % of O₂, such as about 1.5 to about 25 vol. %, about 2 to about 20 vol. %, about 2.5 to about 15 vol. %, about 3 to about 10 vol. %, or about 3.5 to about 7 vol. % based on a total volume of the thermal oxidizer effluent 106. In further embodiments, the thermal oxidizer effluent 106 contains about 2 to about 10 vol. % of O₂ based on the total volume of the thermal oxidizer effluent 106.

The heat released by the combustion reaction that occurs in the thermal oxidizer 104 is at least partially recovered by the integrated boiler of the thermal oxidizer 104 to produce a high pressure steam stream 105. The thermal oxidizer effluent 106 (also referred to as an exhaust gas 106) exits the thermal oxidizer 104 at a temperature of at least about 600° C., such as at least about 550° C., at least about 500° C., at least about 450° C., or at least about 400° C. In further embodiments, the thermal oxidizer effluent 106 exits the thermal oxidizer 104 at a temperature of at least about 400° C. The thermal oxidizer effluent 106 is sent to an oxidative catalytic converter 107. In some embodiments, the oxidative catalytic converter 107 includes a plurality of vertically positioned catalytic beds 108a, 108b, and 108c. Each of the plurality of vertically positioned catalytic beds 108a, 108b, and 108c contains an alkali metal-promoted catalyst. In some embodiments, the alkali metal-promoted catalyst is an alkali metal-promoted vanadium catalyst, in which the alkali metal is selected from the group consisting of cesium, potassium, rubidium, lithium, sodium, and mixtures thereof.

In some embodiments, the thermal oxidizer effluent 106 is passed through an alkali metal-promoted vanadium catalyst present in a series of catalytic beds 108a, 108b, and 108c. The reaction of SO₂ oxidation, shown below is an exothermic reaction (ΔH=−198.4 kj/mol). Therefore, each time the gas stream is going through the catalytic beds 108a, 108b, and 108c; it takes some calories which is recovered by a series of intercoolers 109a and 109b to keep the temperature around about 400° C.

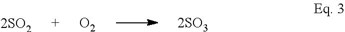

The catalytic beds 108a, 108b, and 108c of the oxidative catalytic converter 107 are regenerated continuously by the excess of O₂ in the thermal oxidizer effluent 106. An oxidized gas stream 110 contains at least SO₃ and SO₂. In some embodiments, the oxidized stream 110 has a temperature of about 400 to about 500° C., such as about 420 to about 480° C., about 440 to about 460° C., or about 450° C. The oxidized gas stream 110 is introduced into a waste heat boiler 111 to be cooled, thereby forming a cooled exit stream 112 (also referred to as an exit stream 111). The cooled exit stream 112 has a temperature of about 100 to about 110° C., such as about 102 to about 108° C., about 104 to about 106° C., or about 105° C. (which is above the water dew point). The cooled exit stream 112 is introduced into a quench tower 113 via a lower section of the quench tower 113.

In some embodiments, the quench tower 113 is in the form of a cylindrical reactor containing an upper section, a body section, and the lower section, and one or more packing zones distributed in the body section of the quench tower. In some embodiments, the quench tower 113 includes one packing zone. The packing zone is a section that offers a large surface to facilitate contact between the liquid phase, i.e., the acidic water, and the gas phase. This also facilitates the removal of SO₂ from the gas phase. A packing zone can vary in material (e.g., plastic, ceramic, and metal), in morphology (e.g., rings, beads, and saddles), and in organization (e.g., structured or random). The packing zone also induces mixing in each phase, to avoid any concentration polarization in the gas phase and/or the liquid phase.

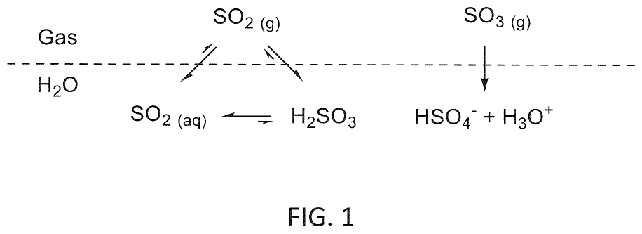

The cooled exit stream 112 is introduced into the quench tower 113 at about 105° C., is cooled further by contacting with a diluted aqueous acid quench stream 116, e.g., a diluted sulfuric acid aqueous solution, introduced from the upper section of the quench tower 113. The diluted aqueous acid quench stream 116 has a temperature of about 40 and about 70° C., such as about 50 to about 60° C., or about 60° C. In some embodiments, the diluted aqueous acid quench stream 116 has a temperature of about 60° C. The cooling action of the diluted aqueous acid quench stream 116 condenses the water vapor contained in the cooled exit stream 112. Sulfur trioxide may react with water, such as a pure water or a slightly acidic water, to afford an acid product, such as sulfuric acid, as shown in FIG. 1. After hydration of the SO₂ and reaction of SO₃ with water, oxidation of the SO₂ occurs in the water phase. Other species present in the thermal oxidizer effluent (N₂, unreacted O₂, uncondensed H₂O, and CO₂) exit the top of the quench tower 113 as a cleaned gaseous stream 115.

The solubility of SO₂ in pure water and its oxidation rate constant vary as a function of temperature. SO₂ has a substantial solubility in pure water and in slightly acidic water, e.g., a sulfuric acid solution with a sulfuric acid concentration of about 2 to 20 wt. %, at a temperature of about 30 to about 70° C., such as about 32 to about 68° C., about 34 to about 66° C., about 36 to about 64° C., about 38 to about 62° C., or about 38 to about 60° C.

In the quench tower 113, sulfur dioxide from the cooled exit stream 112 hydrates and reacts readily with the excess of oxygen present in the thermal oxidizer effluent 106 (E°=+1.1301 V), as shown in Equation 4:

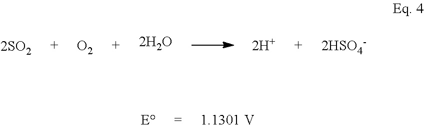

The product of this reaction is sulfuric acid. The rate of the reaction is dependent on the concentration of hydrated sulfur dioxide and independent of the concentration of oxygen, whether the oxygen is dissolved or not. The rate of the oxidation reaction can be expressed as in Equation 5:

$$r = {k [ S {O}_{2} \cdot {H}_{2} O ]}^{\frac{3}{2}} \qquad Eq . 5$$

The rate constant, k, with units of

$${L}^{\frac{3}{2}} \cdot {mol}^{\frac{- 1}{2}} \cdot {s}^{- 1} ,$$

can be expressed as in Equation 6:

$$k = 1.95 \times 1 {0}^{13} {e}^{( \frac{- 86000}{RT} )} \qquad Eq . 6$$

where R is the gas constant and T is the temperature in Kelvin. The rate of the reaction shown in Equation 4 increases as the temperature of the reaction increases. However, the rate of the reaction is not altered by the presence of sulfuric acid. The reaction as shown in Equation 4 takes place in the packing zone of the quench tower 113.

In some embodiments, the cleaned gaseous stream 115 exiting the quench tower 113 contains water vapor (H₂O), CO₂, N₂ and a small amount of O₂. In a further embodiment, the cleaned gaseous stream 115 may optionally contain SO₂. In some embodiments, the cleaned gaseous stream 115 is introduced into a stack, mitigating any SO₂ breakthrough that can occur during upset conditions. Upset conditions occur when SO₂ is not successful treated in the quench tower, for example, when a portion of the SO₂ remains in the gas phase due to poor contacting between the gas and liquid phases (e.g., channeling of the gas stream or lowering of liquid-to-gas ratio). The addition of the condensed water and the produced sulfuric acid to the diluted aqueous acid quench stream 116 maintains a mass concentration of sulfuric acid in an amount of about 0.2 to 20 wt. %, such as about 1 to about 18 wt. %, about 2 to about 16 wt. %, about 4 to about 12 wt. %, or about 8 to about 10 wt. % at the bottom of the quench tower 113. The diluted aqueous acid product stream 114 (also referred to as an acidic aqueous stream 114) exits the lower section of the quench tower 113, and is sent to a cooler 119 with via a first pump 117. An aqueous stream 118 entering the heat exchanger, or air cooler 119 is cooled from about 70-80° C. to about 50-60° C. The cooled diluted aqueous acid product stream 120 (also referred to as a cooled stream 120) is introduced to a buffer tank 122 (also referred to as a collection tank 122). The buffer tank 122 is in fluid communication with the upper section 116 of the quench tower 113 via the diluted aqueous acid quench stream 116, originated from a diluted sulfuric acid stream 123 through a second pump 121. The buffer tank 122 is equipped with a vent 124, where a blanket of inert atmosphere can be provided by injecting inert gas to avoid any potential SO₂ emission. The vent 124 is equipped with a small column where a clean water stream is circulated, or a gas line is equipped with a water trap. A makeup stream 126 is used to fill the buffer tank 122 prior to the startup of the process. An aqueous solution 125 from the buffer tank 122 is sent using a third pump 127 to a water treatment unit 129 to remove sulfuric acid. In some embodiments, the water treatment unit 129 is selected from the group consisting of a reverse osmosis (RO) membrane unit, an electrodialysis unit, a distillation unit, and combinations thereof. In some embodiments, the water treatment unit 129 is a RO membrane unit. In some embodiments, the RO membrane unit yields a permeate that is substantially water and a retentate containing about 0.5 to about 15 wt. % of H₂SO₄, such as about 1 to about 12.5 wt. %, about 2 to about 10 wt. %, about 3 to about 5 wt. %, or about 3 wt. % of H₂SO₄.

In some embodiments, the water treatment unit 129 is an electrodialysis unit. In some embodiments, the electrodialysis unit yields a diluate that is substantially water and a concentrate containing about 1 to about 40 wt. % of H₂SO₄, such as about 5 to about 35 wt. %, about 10 to about 30 wt. %, about 20 to about 25 wt. %, or about 20 wt. % of H₂SO₄.

In some embodiments, the water treatment unit 129 is a distillation unit. The distillation unit is configured to concentrate the diluted aqueous acid buffer stream 125 using part of the steam generated from the thermal oxidizer, or by utilizing heat from a waste heat recovery system installed downstream of the reaction furnace of the Claus process. In some embodiments, the distillation unit yields a distillate that is substantially water and a residue containing about 30 to about 98 wt. % of H₂SO₄, such as about 10 to about 98 wt. %, about 50 to about 98 wt. %, about 70 to about 98 wt. %, or about 98 wt. % of H₂SO₄.

The permeate stream 130 is sent to the buffer tank 122 (also referred to as a collection tank 122) or to evaporation ponds (not represented) when the buffer tank 122 is full. The retentate 131 is mainly concentrated sulfuric acid having a sulfuric acid concentration of about 3 to about 98 wt. %. This retentate stream 131 can be monetized by producing concentrated sulfuric acid or sent to the SRU to enrich the Claus furnace in oxygen.

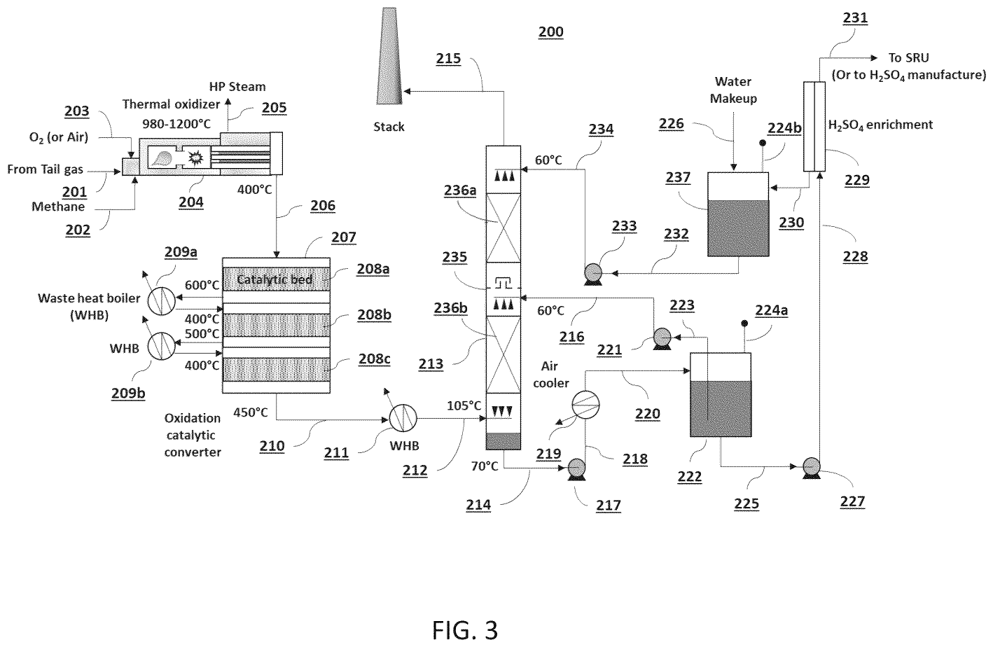

FIG. 3 is an example schematic of a system 200 for removing SO₂ from a gaseous stream. The system 200 includes a multi-stage quench tower 213 for the SO₂ removal from a thermal oxidizer effluent 206. The thermal oxidizer effluent 206 is the result of the complete combustion of H₂S and other sulfur-containing compounds, for example, sulfur vapor, COS, and CS₂, in a thermal oxidizer 204. The thermal oxidizer effluent 206 contains at least SO₂ and O₂. In further embodiments, the thermal oxidizer effluent 206 also contains SO₃, H₂O, CO₂, and N₂. In some embodiments, a tail gas 201 containing CO, one or more sulfur-containing compounds, water vapor, N₂, and CO₂ is introduced into the thermal oxidizer 204. In some embodiments, the one or more sulfur-containing compounds are selected from the group consisting of H₂S, SO₂, sulfur vapor, COS, and CS₂. In further embodiments, the one or more sulfur-containing compounds are H₂S and SO₂. In some embodiments, the H₂S and SO₂ are present in the tail gas 201 at a ratio of about 8:1 to about 1:4, such as about 6:1 to about 1:2, about 4:1 to about 1:1, or about 2:1. In further embodiments, the H₂S and SO₂ are present in the tail gas 201 at a ratio of about 2:1.

The tail gas 201 is sent to the thermal oxidizer 204 in the presence of a combustible gas 202, such as methane, and an oxidant gas 203, such as O₂, originated from the air or an oxygen-enriched source. The combustion reaction that occurs in the thermal oxidizer 204 transforms a fluid composition containing the tail gas 201, the combustible gas 202, and the oxidant gas 203, into the thermal oxidizer effluent 206. The thermal oxidizer effluent 206 includes, but is not limited to, H₂O, CO₂, SO₂, and an excess of O₂. In some embodiments, the thermal oxidizer effluent 206 further includes traces of SO₃ and N₂. In some embodiments, the thermal oxidizer effluent 206 contains about 1 to about 30 vol. % of O₂, such as about 1.5 to about 25 vol. %, about 2 to about 20 vol. %, about 2.5 to about 15 vol. %, about 3 to about 10 vol. %, or about 3.5 to about 7 vol. % based on a total volume of the thermal oxidizer effluent 206. In further embodiments, the thermal oxidizer effluent 206 contains about 2 to about 10 vol. % of O₂ based on the total volume of the thermal oxidizer effluent 206.

The heat released by the combustion reaction that occurs in the thermal oxidizer 204 is at least partially recovered by the integrated boiler of the thermal oxidizer 204 to produce a high pressure steam stream 205. The thermal oxidizer effluent 206 (also referred to as an exhaust gas 206) exits the thermal oxidizer 204 at a temperature of at least about 600° C., such as at least about 550° C., at least about 500° C., at least about 450° C., or at least about 400° C. In further embodiments, the thermal oxidizer effluent 206 exits the thermal oxidizer 204 at a temperature of at least about 400° C. The thermal oxidizer effluent 206 is sent to an oxidative catalytic converter 207. In some embodiments, the oxidative catalytic converter 207 includes a plurality of vertically positioned catalytic beds 208a, 208b, and 208c. Each of the plurality of vertically positioned catalytic beds 208a, 208b, and 208c contains an alkali metal-promoted catalyst. In some embodiments, the alkali metal-promoted catalyst is an alkali metal-promoted vanadium catalyst, in which the alkali metal is selected from the group consisting of cesium, potassium, rubidium, lithium, sodium, and mixtures thereof.

In some embodiments, the thermal oxidizer effluent 206 is passed through an alkali metal-promoted vanadium catalyst present in a series of catalytic beds 208a, 208b, and 208c. The reaction of SO₂ oxidation, shown in Equation 3 is an exothermic reaction (ΔH=−198.4 kj/mol). Therefore, each time the gas stream is going through the catalytic beds 208a, 208b, and 208c; it takes some calories which is recovered by a series of intercoolers 209a and 209b to keep the temperature around about 400° C.

The catalytic beds 208a, 208b, and 208c of the oxidative catalytic converter 207 are regenerated continuously by the excess of O₂ in the exhaust gas 206. An oxidized gas stream 210 contains at least SO₃ and SO₂ and has a temperature of about 400 to about 500° C., such as about 420 to about 480° C., about 440 to about 460° C., or about 450° C. The oxidized gas stream 210 is introduced into a waste heat boiler 211 to be cooled, thereby forming a cooled exit stream 212 (also referred to as an exit stream 212). The cooled exit stream 212 has a temperature of about 100 to about 110° C., such as about 102 to about 108° C., about 104 to about 106° C., or about 105° C. (which is above the water dew point). The cooled exit stream 212 is introduced into a quench tower 213 via a lower section of the quench tower 213.

In some embodiments, the quench tower 213 is in the form of a cylindrical reactor containing an upper section 236a, the lower section 236b, a body section, and two or more packing zones distributed in the upper section 236a and lower section 236b of the quench tower 213. In some embodiments, the quench tower 213 includes two or more packing zones, such as 2, 3, 4, 5, 6, 7, 8, 9, or 10 packing zones. In further embodiments, the quench tower 213 includes two packing zones. Each of the two packing zones is located within the upper section 236a and lower section 236b of the quench tower 213. The two packing zones are separated by a perforated plate 235 configured to allow gas molecules to pass through and redistribute water within the two packing zones. The perforated plate 235 is located within the body section of the quench tower 213. The packing zone is a section that offers a large surface to facilitate contact between the liquid phase, i.e., the acidic water, and the gas phase. This also facilitates the removal of SO₂ from the gas phase. A packing zone can vary in material (e.g., plastic, ceramic, and metal), in morphology (e.g., rings, beads, and saddles), and in organization (e.g., structured or random). The packing zone also induces mixing in each phase, to avoid any concentration polarization in the gas phase and/or the liquid phase.

The cooled exit stream 212 is introduced into a bottom of the lower section 236b of the quench tower 213 at about 105° C., and is cooled further by contacting with a diluted aqueous acid quench stream 216, e.g., a diluted sulfuric acid aqueous solution, introduced from a top of a lower section 236b of the quench tower 213. The diluted aqueous acid quench stream 216 has a temperature of about 40 and about 70° C., such as about 50 to about 60° C., or about 60° C. In some embodiments, the diluted aqueous acid quench stream 216 has a temperature of about 60° C. The cooling action of the diluted aqueous acid quench stream 216 condensates the water vapor contained in the cooled exit stream 212. Sulfur trioxide may react with water, such as a pure water or a slightly acidic water, to afford an acid product, such as a sulfuric acid, as shown in FIG. 1. After hydration of the SO₂ and reaction of SO₃ with water, oxidation of the SO₂ occurs in the water phase. Other species present in the thermal oxidizer effluent (N₂, unreacted O₂, uncondensed H₂O, and CO₂) exit the top of the quench tower 213 as a cleaned gaseous stream 215.

In the quench tower 213, SO₂ from the cooled exit stream 212 hydrates and reacts readily with the excess of oxygen present in the thermal oxidizer effluent 206. The product of this reaction is also sulfuric acid. The rate of the reaction increases as the temperature of the reaction increases. However, the rate of the reaction is not altered by the presence of sulfuric acid. This reaction takes place in the packing zones of the upper section 236a and lower section 236b of the quench tower 213. The cleaned gaseous stream 215 exits the quench tower 213 from a top of the upper section 236a of the quench towers 213. The cleaned gaseous stream 215 contains H₂O, CO₂, N₂ and a small amount of O₂. In some embodiments, the cleaned gaseous stream 215 is introduced into a stack, mitigating any SO₂ breakthrough that can occur during upset conditions. Upset conditions occur when SO₂ is not successful treated in the quench tower, for example, when a portion of the SO₂ remains in the gas phase due to poor contacting between the gas and liquid phases (e.g., channeling of the gas stream or lowering of liquid-to-gas ratio). The addition of the condensed water and the produced sulfuric acid to the diluted sulfuric aqueous stream 216 maintains a mass concentration of sulfuric acid in an amount of about 0.2 to 20 wt. %, such as about 1 to about 18 wt. %, about 2 to about 16 wt. %, about 4 to about 12 wt. %, or about 8 to about 10 wt. % at the bottom of the quench tower 213. The diluted aqueous acid product stream 214 (also referred to as an acidic aqueous stream 114) exits the lower section 236b of the quench tower 213, and is sent to a cooler 219 with via a first pump 217. An aqueous stream 218 entering the heat exchanger, or an air cooler 219 is cooled from about 70-80° C. to about 50-60° C. The cooled diluted aqueous acid product stream 220 (also referred to as a cooled stream 220) is introduced to a first buffer tank 222. The first buffer tank 222 (also referred to as a first collection tank 222) is in fluid communication with the top of the lower section 236b of the quench tower 213 via the diluted aqueous acid quench stream 216 (also referred to as a diluted sulfuric acid stream 216), originated from a diluted sulfuric acid stream 223 through a second pump 221. The first buffer tank 222 is equipped with a first vent 224a, where a blanket of inert atmosphere can be provided by injecting inert gas to avoid any potential SO₂ emission. The first vent 224a is equipped with a small column where a clean water stream is circulated, or a gas line is equipped with a water trap.

An aqueous solution 225, e.g., a cooled diluted sulfuric acid product stream, from the first buffer tank 222 is sent using a second pump 227 to a water treatment unit 229 to remove sulfuric acid. In some embodiments, the water treatment unit 229 is selected from the group consisting of a reverse osmosis (RO) membrane unit, an electrodialysis unit, a distillation unit, and combinations thereof. In some embodiments, the water treatment unit 229 is a RO membrane unit. In some embodiments, the RO membrane unit yields a permeate that is substantially water and a retentate containing about 0.5 to about 15 wt. % of H₂SO₄, such as about 1 to about 12.5 wt. %, about 2 to about 10 wt. %, about 3 to about 5 wt. %, or about 3 wt. % of H₂SO₄.

In some embodiments, the water treatment unit 229 is an electrodialysis unit. In some embodiments, the electrodialysis unit yields a diluate that is substantially water and a concentrate containing about 1 to about 40 wt. % of H₂SO₄, such as about 5 to about 35 wt. %, about 10 to about 30 wt. %, about 20 to about 25 wt. %, or about 20 wt. % of H₂SO₄.

In some embodiments, the water treatment unit 229 is a distillation unit. The distillation unit is configured to concentrate the diluted aqueous acid buffer stream 225 using part of the steam generated from the thermal oxidizer, or by utilizing heat from a waste heat recovery system installed downstream of the reaction furnace of the Claus process. In some embodiments, the distillation unit yields a distillate that is substantially water and a residue containing about 3 to about 98 wt. % of H₂SO₄, such as about 10 to about 98 wt. %, about 50 to about 98 wt. %, about 70 to about 98 wt. %, or about 98 wt. % of H₂SO₄.

This permeate stream 230 is sent to a second buffer tank 237 (also referred to as a second collection tank 237) or to evaporation ponds (not shown) when the buffer tanks 237 and 222 are full. The second buffer tank 237 is fitted with a second vent 224b. If the concentration of SO₂ and sulfuric acid in the fresh water is low, the second buffer tank 237 can be vented to the open air. The venting process can ensure that any liquid sent to a subsequent membrane process is free from gas and minimizes degassing in a subsequent membrane process. In addition, the vent can be used to equilibrate the pressure in the buffer tank when the third pump 233 is in operation. In some implementations, the second vent 224b can be connected to the lower section 236b of the quench tower 213. The retentate stream 231 is mainly concentrated sulfuric acid having a sulfuric acid concentration of about 3 to about 98 wt. %. This retentate stream 231 can be monetized by producing concentrated sulfuric acid or sent to the SRU to enrich the Claus furnace in oxygen. A makeup stream 226 is used to fill the second collection tank 237 prior to the startup of the process. A highly diluted acidic water stream 232 is sent to the top of the upper section 236a of the quench tower 213 via a third pump 233. The upper section 236a of the quench tower 213 is for polishing the gas from SO₂ and is connected to the lower section 236b of the quench tower 213 by a perforated plate 235 to redistribute the water in the packing zones of the lower section 236b.

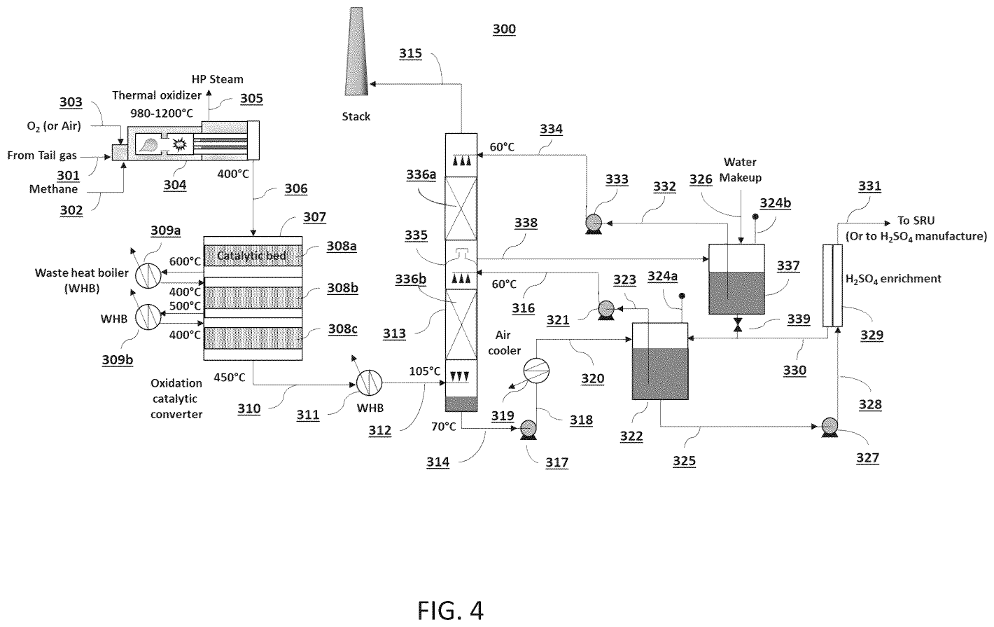

FIG. 4 is an example schematic of a system 300 for removing SO₂ from a gaseous stream. The system 300 includes a polishing-stage quench tower 313 for the SO₂ removal from a thermal oxidizer effluent 306. The thermal oxidizer effluent 306 is the result of the complete combustion of H₂S and other sulfur-containing compounds, for example, sulfur vapor, COS, and CS₂, in a thermal oxidizer 304. The thermal oxidizer effluent 306 contains at least SO₂ and O₂. In some embodiments, the thermal oxidizer effluent 306 also contains SO₃, H₂O, CO₂, and N₂. In some embodiments, a tail gas 301 containing CO, one or more sulfur-containing compounds, water vapor, N₂, and CO₂ is introduced into the thermal oxidizer 304. In some embodiments, the one or more sulfur-containing compounds are selected from the group consisting of H₂S, SO₂, sulfur vapor, COS, and CS₂. In further embodiments, the one or more sulfur-containing compounds are H₂S and SO₂. In some embodiments, the H₂S and SO₂ are present in the tail gas 301 at a ratio of about 8:1 to about 1:4, such as about 6:1 to about 1:2, about 4:1 to about 1:1, or about 2:1. In further embodiments, the H₂S and SO₂ are present in the tail gas 301 at a ratio of about 2:1.

The tail gas 301 is sent to the thermal oxidizer 304 in the presence of a combustible gas 302, such as methane, and an oxidant gas 303, such as O₂, originated from the air or an oxygen-enriched source. The combustion reaction that occurs in the thermal oxidizer 304 transforms a fluid composition containing the tail gas 301, the combustible gas 302, and the oxidant gas 303, into the thermal oxidizer effluent 306. The thermal oxidizer effluent 306 includes, but is not limited to, H₂O, CO₂, SO₂, and an excess of O₂. In some embodiments, the thermal oxidizer effluent 306 further includes traces of SO₃ and N₂. In some embodiments, the thermal oxidizer effluent 306 contains about 1 to about 30 vol. % of O₂, such as about 1.5 to about 25 vol. %, about 2 to about 20 vol. %, about 2.5 to about 15 vol. %, about 3 to about 10 vol. %, or about 3.5 to about 7 vol. % of O₂ based on a total volume of the thermal oxidizer effluent 306. In further embodiments, the thermal oxidizer effluent 306 contains about 2 to about 10 vol. % of O₂ based on the total volume of the thermal oxidizer effluent 306.

The heat released by the combustion reaction that occurs in the thermal oxidizer 304 is at least partially recovered by the integrated boiler of the thermal oxidizer 304 to produce a high pressure steam stream 305. The thermal oxidizer effluent 306 (also referred to as an exhaust gas 306) exits the thermal oxidizer 304 at a temperature of at least about 600° C., such as at least about 550° C., at least about 500° C., at least about 450° C., or at least about 400° C. In further embodiments, the thermal oxidizer effluent 306 exits the thermal oxidizer 304 at a temperature of at least about 400° C. The thermal oxidizer effluent 306 is sent to an oxidative catalytic converter 307. In some embodiments, the oxidative catalytic converter 307 includes a plurality of vertically positioned catalytic beds 308a, 308b, and 308c. Each of the plurality of vertically positioned catalytic beds 308a, 308b, and 308c contains an alkali metal-promoted catalyst. In some embodiments, the alkali metal-promoted catalyst is an alkali metal-promoted vanadium catalyst, in which the alkali metal is selected from the group consisting of cesium, potassium, rubidium, lithium, sodium, and mixtures thereof.

In some embodiments, the thermal oxidizer effluent 306 is passed through an alkali metal-promoted vanadium catalyst present in a series of catalytic beds 308a, 308b, and 308c. The reaction of SO₂ oxidation, shown in Equation 3 is an exothermic reaction (ΔH=−198.4 kj/mol). Therefore, each time the gas stream is going through the catalytic beds 308a, 308b, and 308c; it takes some calories which is recovered by a series of intercoolers 309a and 309b to keep the temperature around about 400° C.

The catalytic beds 308a, 308b, and 308c of the oxidative catalytic converter 307 are regenerated continuously by the excess of O₂ in the exhaust gas 306. An oxidized gas stream 310 contains at least SO₃ and SO₂ and has a temperature of about 400 to about 500° C., such as about 420 to about 480° C., about 440 to about 460° C., or about 450° C. The oxidized gas stream 310 is introduced into a waste heat boiler 311 to be cooled, thereby forming a cooled exit stream 312 (also referred to as an exit stream 312). The cooled exit stream 312 has a temperature of about 100 to about 110° C., such as about 102 to about 108° C., about 104 to about 106° C., or about 105° C. (which is above the water dew point). The cooled exit stream 312 is introduced into a quench tower 313 via a bottom of the lower section 336b of the quench tower 313.

In some embodiments, the quench tower 313 is in the form of a cylindrical reactor containing an upper section 336a, the lower section 336b, a body section, and two or more packing zones distributed in the upper section 336a and lower section 336b of the quench tower 313. In some embodiments, the quench tower 313 includes two or more packing zones, such as 2, 3, 4, 5, 6, 7, 8, 9, or 10 packing zones. In further embodiments, the quench tower 313 includes two packing zones. Each of the two packing zones is located within the upper section 336a and lower section 336b of the quench tower 313. The two packing zones are separated by a plate 335 configured to allow gas molecules to pass through via a plurality of bubble caps and collect the fresh water to be sent to a second buffer tank 337. The plate 335 is located within the body section of the quench tower 313. The packing zone is a section that offers a large surface to facilitate contact between the liquid phase, i.e., the acidic water, and the gas phase. This also facilitates the removal of SO₂ from the gas phase. A packing zone can vary in material (e.g., plastic, ceramic, and metal), in morphology (e.g., rings, beads, and saddles), and in organization (e.g., structured or random). The packing zone also induces mixing in each phase, to avoid any concentration polarization in the gas phase and/or the liquid phase.

The cooled exit stream 312 is introduced into the quench tower 313 at about 105° C., and is cooled further by contacting with a diluted aqueous acid quench stream 316, e.g., a diluted sulfuric acid aqueous solution, introduced from a top of the lower section 336b of the quench tower 313. The diluted aqueous acid quench stream 316 has a temperature of about 40 and about 70° C., such as about 50 to about 60° C., or about 60° C. In some embodiments, the diluted aqueous acid quench stream 316 has a temperature of about 60° C. The cooling action of the diluted aqueous acid quench stream 316 condensates the water vapor contained in the cooled exit stream 312. Sulfur trioxide may react with water, such as a pure water or a slightly acidic water, to afford an acid product, such as a sulfuric acid, as shown in FIG. 1. After hydration of the SO₂ and reaction of SO₃ with water, oxidation of the SO₂ occurs in the water phase. Other species present in the thermal oxidizer effluent (N₂, unreacted O₂, uncondensed H₂O, and CO₂) exit the top of the quench tower 313 as a cleaned gaseous stream 315.

In the quench tower 313, sulfur dioxide from the cooled exit stream 312 hydrates and reacts readily with the excess of oxygen present in the thermal oxidizer effluent 306. The product of this reaction is also sulfuric acid. The rate of the reaction increases as the temperature of the reaction increases. However, the rate of the reaction is not altered by the presence of sulfuric acid. This reaction takes place in the packing zones of the upper section 336a and lower section 336b of the quench tower 313. The cleaned gaseous stream 315 exits the quench tower 313 from a top of the upper section 336a of the quench towers 313. The cleaned gaseous stream 315 contains H₂O, CO₂, N₂ and a small amount of O₂. In some embodiments, the cleaned gaseous stream 315 is introduced into a stack, mitigating any SO₂ breakthrough that can occur during upset conditions. Upset conditions occur when SO₂ is not successful treated in the quench tower, for example, when a portion of the SO₂ remains in the gas phase due to poor contacting between the gas and liquid phases (e.g., channeling of the gas stream or lowering of liquid-to-gas ratio). The addition of the condensed water and the produced sulfuric acid to the diluted sulfuric aqueous stream 316 maintains a mass concentration of sulfuric acid in an amount of about 0.2 to about 20 wt. %, such as about 1 to about 18 wt. %, about 2 to about 16 wt. %, about 4 to about 12 wt. %, or about 8 to about 10 wt. % at the bottom of the quench tower 313. The diluted aqueous acid product stream 314 (also referred to as an acidic aqueous stream 314) exits the lower section 336b of the quench tower 313, and is sent to a cooler 319 with via a first pump 317. An aqueous stream 318 entering the heat exchanger, or a cooler 319 is cooled from about 70-80° C. to about 50-60° C. The cooled diluted aqueous acid product stream 320 (also referred to as a cooled stream 320) is introduced to a first buffer tank 322. The first buffer tank 322 (also referred to as a first collection tank 322) is in fluid communication with the top of the lower section 336b of the quench tower 313 via a diluted aqueous acid quench stream 316 (also referred to as a diluted sulfuric acid stream 316), originated from a sulfuric acid stream 323 through a second pump 321. The first buffer tank 322 is equipped with a vent 324a, where a blanket of inert atmosphere is provided by injecting inert gas to avoid any potential SO₂ emission. The vent 324a is equipped with a small column where a clean water stream is circulated, or a gas line is equipped with a water trap.

An aqueous solution 325, e.g., a cooled diluted aqueous acid product stream, from the first buffer tank 322 is sent using a third pump 327 to a water treatment unit 329 to remove sulfuric acid. In some embodiments, the water treatment unit 329 is selected from the group consisting of a RO membrane unit, an electrodialysis unit, a distillation unit, and combinations thereof. In some embodiments, the water treatment unit 329 is a RO membrane unit. In some embodiments, the RO membrane unit yields a permeate that is substantially water and a retentate containing about 0.5 to about 15 wt. % of H₂SO₄, such as about 1 to about 12.5 wt. %, about 2 to about 10 wt. %, about 3 to about 5 wt. %, or about 3 wt. % of H₂SO₄.

In some embodiments, the water treatment unit 329 is an electrodialysis unit. In some embodiments, the electrodialysis unit yields a diluate that is substantially water and a concentrate containing about 1 to about 40 wt. % of H₂SO₄, such as about 5 to about 35 wt. %, about 10 to about 30 wt. %, about 20 to about 25 wt. %, or about 20 wt. % of H₂SO₄.

In some embodiments, the water treatment unit 329 is a distillation unit. The distillation unit is configured to concentrate the diluted aqueous acid buffer stream 325 using part of the steam generated from the thermal oxidizer, or by utilizing heat from a waste heat recovery system installed downstream of the reaction furnace of the Claus process. In some embodiments, the distillation unit yields a distillate that is substantially water and a residue containing about 3 to about 98 wt. % of H₂SO₄, such as about 10 to about 98 wt. %, about 50 to about 98 wt. %, about 70 to about 98 wt. %, or about 98 wt. % of H₂SO₄.

This permeate stream 330 is sent to a second buffer tank 337 (also referred to as a second collection tank 337) or to evaporation ponds (not shown) when the first buffer tank 322 is full. If the concentration of SO₂ and sulfuric acid in the recovered fresh water 338 is low, the second buffer tank 337 can be vented to the open air. The venting process can ensure that any liquid sent to a subsequent membrane process is free from gas and minimizes degassing in a subsequent membrane process. In addition, the vent can be used to equilibrate the pressure in the buffer tank when the third pump 333 is in operation. In some implementations, the second vent 324b can be connected to the lower section 336b of the quench tower 313. The retentate stream 331 is mainly concentrated sulfuric acid having a sulfuric acid concentration of about 3-98 wt. %. This retentate stream 331 can be monetized by producing concentrated sulfuric acid or sent to the SRU to enrich the Claus furnace in oxygen content by enhancing the combustion process in the Claus furnace. A makeup stream 326 is used to fill the second buffer tank 337 prior to the startup of the process.

The oxidation of hydrated sulfur dioxide into sulfuric acid takes place substantially in the packing zone of the lower section 336b of the quench tower 313. If there is variation (upset) in the fluid composition or flowrate of the thermal oxidizer effluent 306, the oxidation of the sulfur dioxide breaking through the lower section 336b occurs in the upper section 336a of the quench tower 313, which is defined as a polishing stage.

A highly diluted acidic water stream 332 is sent to the top of the upper section 336a of the quench tower 313 via a fourth pump 333. The upper section 336a of the quench tower 313 is connected to the lower section 313 of the quench tower 313 by a plate 335 located within the body section of the quench tower 313. The plate 335 is configured to allow gas molecules to pass through via a plurality of bubble caps and collects the fresh water to be sent to the second buffer tank 337 via a fresh water stream 338.

As breakthrough of sulfur dioxide (or/and sulfur trioxide) happens, the pH of the fresh water stream 338 will decrease from about 3 (about 0.01 wt. % in sulfuric acid) to about 0.5 (3 wt. % in sulfuric acid). When the pH reaches 0.5, the water stream exiting the collection tank 337 via the valve 339 is diverted to the first buffer tank 322 via the permeate stream 330. The acidic water is therefore treated using the water treatment unit 329. The fresh water makeup is added to the polishing loop, via the makeup stream 326, and subsequently to the second buffer tank 337.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### EMBODIMENTS

Embodiment 1: A method for treating a sulfur dioxide (SO₂) containing gaseous stream, the method comprising:
introducing a thermal oxidizer effluent in a gaseous form comprising oxygen (O₂) and SO₂ into an oxidative catalytic converter comprising a plurality of vertically positioned catalytic beds, wherein each of the plurality of vertically positioned catalytic beds comprises an alkali metal-promoted catalyst;
passing the thermal oxidizer effluent through the oxidative catalytic converter to contact the thermal oxidizer effluent with the alkali metal-promoted catalyst, thereby oxidizing at least a portion of the SO₂ to sulfur trioxide (SO₃) with the O₂ from the thermal oxidizer effluent and producing a spent catalyst and an oxidized gas stream leaving the oxidative catalytic converter;
cooling the oxidized gas stream in a waste heat recovery system to generate a cooled exit stream;
introducing the cooled exit stream into a quench tower comprising one or more packing zones;
contacting the cooled exit stream with a diluted aqueous acid quench stream in the quench tower to dissolve the SO₃ and the rest of the portion of the SO₂ in the diluted aqueous acid quench stream, thereby generating sulfurous acid (H₂SO₃), hydrated sulfur dioxide, and sulfuric acid (H₂SO₄); and
oxidizing the H₂SO₃ and the hydrated sulfur dioxide with the O₂ from the thermal oxidizer effluent in the one or more packing zones, thereby generating a diluted aqueous acid product stream comprising H₂SO₄ leaving the quench tower.

Embodiment 2: The method of embodiment 1, comprising combusting a fluid composition in a thermal oxidizer to generate the thermal oxidizer effluent comprising the O₂ and SO₂, wherein the fluid composition comprises a combustible gas, an oxygen-containing oxidant gas, and a tail gas comprising one or more sulfur-containing compounds.

Embodiment 3: The method of embodiment 1 or 2, wherein the oxygen-containing oxidant gas comprises a number of moles of oxygen exceeding the number of moles of oxygen required to fully combust the sulfur-containing compounds and the combustible gas.

Embodiment 4: The method of any one of embodiments 1-3, wherein:
the one or more sulfur-containing compounds are selected from the group consisting of hydrogen sulfide (H₂S), SO₂, sulfur vapor, carbonyl sulfide (COS), and carbon disulfide (CS₂); and the combustible gas is selected from the group consisting of methane, propane, butane, ethylene, propylene, acetylene, hydrogen, natural gas, ethane, methanol, ethanol, and mixtures thereof.

Embodiment 5: The method of any one of embodiments 1-4, wherein the O₂ is present in the thermal oxidizer effluent in an amount of about 2 to about 30 vol. % by a total volume of the thermal oxidizer effluent.

Embodiment 6: The method of any one of embodiments 1-5, wherein the alkali metal-promoted catalyst is an alkali metal-promoted vanadium catalyst, and wherein the alkali metal is selected from the group consisting of cesium, potassium, rubidium, lithium, sodium, and mixtures thereof.

Embodiment 7: The method of embodiments 1-6, wherein the alkali metal-promoted catalyst is regenerated in-situ in the oxidative catalytic converter by reacting the spent catalyst with the O₂ from the thermal oxidizer effluent during the passing.

Embodiment 8: The method of embodiments 1-7, wherein the H₂SO₄ is present in the diluted aqueous acid product stream in an amount of about 0.1 and about 10 wt. % by a total weight of the diluted aqueous acid product stream.

Embodiment 9: The method of embodiments 1-8, wherein the quench tower is in the form of a cylindrical reactor comprising an upper section, a lower section, and two or more packing zones evenly distributed within the upper section and lower section of the quench tower, wherein the two or more packing zones are separated by a perforated plate configured to allow gas molecules to pass through and redistribute water within packing zones of the lower section.

Embodiment 10: The method of embodiments 1-9, wherein the upper section and the lower section are connected via the perforated plate.

Embodiment 11: The method of embodiments 1-10, further comprising:
cooling the diluted aqueous acid product stream in a cooler to generate a cooled diluted aqueous acid product stream comprising H₂SO₄; and
introducing the cooled diluted aqueous acid product stream comprising H₂SO₄ into a buffer tank, wherein the buffer tank is in fluid communication with the quench tower via the diluted aqueous acid quench stream, and wherein the buffer tank is in fluid communication with a water treatment unit via a diluted aqueous acid buffer stream.

Embodiment 12: The method of embodiments 1-11, wherein the water treatment unit generates a permeate that is substantially water and a H₂SO₄-containing retentate having a H₂SO₄ concentration of about 3 to about 98 wt. % of the H₂SO₄-containing retentate.

Embodiment 13: The method of embodiments 1-12, further comprising introducing the permeate of the water treatment unit to the buffer tank.

Embodiment 14: A system for sulfur dioxide (SO₂) removal, the system comprising:
a thermal oxidizer configured to receive and combust a fluid composition comprising a combustible gas, an oxygen (O₂)-containing oxidant gas, and a tail gas to generate a thermal oxidizer effluent comprising sulfur dioxide (SO₂) and O₂;
an oxidative catalytic converter coupled to the thermal oxidizer and configured to oxidize at least a portion of the SO₂ to SO₃ with the O₂ from the thermal oxidizer effluent and produce a spent catalyst and an oxidized gas stream leaving the oxidative catalytic converter; a waste heat recovery system coupled to the oxidative catalytic converter and configured to cool the oxidized gas stream to generate a cooled exit stream;
a quench tower comprising one or more packing zones coupled to the waste heat recovery system and configured to receive the cooled exit stream, and contact the cooled exit stream with a diluted aqueous acid quench stream to dissolve the SO₃ and the rest portion of the SO₂ in the diluted aqueous acid quench stream to generate sulfurous acid (H₂SO₃), hydrated sulfur dioxide, and sulfuric acid (H₂SO₄), and to oxidize the H₂SO₃ and the hydrated sulfur dioxide with the O₂ from the thermal oxidizer effluent to generate a diluted aqueous acid product stream comprising H₂SO₄ leaving the quench tower;
a cooler coupled to the quench tower and configured to receive and cool the diluted aqueous acid product stream to generate a cooled diluted aqueous acid product stream;
a first buffer tank coupled to the cooler and configured to receive the cooled diluted aqueous acid product stream and generate a diluted aqueous acid buffer stream comprising H₂SO₄; and
a water treatment unit coupled to the buffer tank and configured to receive the diluted aqueous acid buffer stream comprising H₂SO₄ and generate a permeate and a H₂SO₄-containing retentate.

Embodiment 15: The system of embodiment 14, wherein the buffer tank further comprises a vent, wherein the vent is connected to a clean water stream or a water trap.

Embodiment 16: The system of embodiment 14 or 15, wherein the water treatment unit is selected from the group consisting of a reverse osmosis (RO) membrane unit, an electrodialysis unit, a distillation unit, and combinations thereof.

Embodiment 17: The system of any one of embodiments 14-16, wherein the water treatment unit is a RO membrane unit, and wherein the RO membrane unit yields a permeate that is substantially water and a retentate comprising about 3 to about 98 wt. % of H₂SO₄.

Embodiment 18: The system of any one of embodiments 14-17, wherein the thermal oxidizer effluent is introduced into the oxidative catalytic converter at a temperature of about 400° C.

Embodiment 19: The system of any one of embodiments 14-18, wherein the waste heat recovery system is configured to cool the oxidized gas stream to a temperature of about 105° C.

Embodiment 20: The system of any one of embodiments 14-19, wherein the diluted aqueous acid quench stream is introduced into the quench tower at a temperature of about 40 to about 65° C.

Embodiment 21: The system of any one of embodiments 14-20, wherein the diluted aqueous acid product stream comprises about 0.1 to about 10 wt. % of H₂SO₄.

Embodiment 22: The system of any one of embodiments 14-21, wherein the quench tower is in the form of a cylindrical reactor comprising an upper section, a lower section, and two or more packing zones evenly distributed in the upper section and lower section of the quench tower, wherein the two or more packing zones are separated by a perforated plate configured to allow gas molecules to pass through and redistribute water within packing zones of the lower section.

Embodiment 23: The system of any one of embodiments 14-22, further comprising:
a second buffer tank coupled between the quench tower and the water treatment unit, wherein the second buffer tank is configured to bypass the water treatment unit and receive the diluted aqueous acid buffer stream from the first buffer tank or receive the permeate from the water treatment unit, and configured to flow the diluted aqueous acid buffer stream to the upper section of the quench tower.

Embodiment 24: The system of any one of embodiments 14-23, wherein the quench tower is in the form of a cylindrical reactor comprising:
an upper section, a lower section, and two or more packing zones evenly distributed in the upper section and lower section of the quench tower, wherein the two or more packing zones are separated by a plate, wherein the plate comprises a plurality of bubble caps, and is configured to allow gas molecules to pass through the plate and collect recovered water, resulting in the formation of a fresh water stream; and
a pH monitor configured to monitor the pH of the fresh water stream.

Embodiment 25: The system of any one of embodiments 14-24, further comprising:
a second buffer tank coupled between the quench tower, the water treatment unit, and the first buffer bank, wherein the second buffer tank is configured to bypass the water treatment unit and receive the diluted aqueous acid buffer stream from the first buffer tank, or receive the permeate from the water treatment unit, configured to flow the diluted aqueous acid buffer stream to the upper section of the quench tower, and configured to receive the fresh water stream from the quench tower via a valve when the pH of the recovered water is below 0.5.

1. A method for treating a sulfur dioxide (SO₂) containing gaseous stream, the method comprising:
introducing a thermal oxidizer effluent in a gaseous form comprising oxygen (O₂) and SO₂ into an oxidative catalytic converter comprising a plurality of vertically positioned catalytic beds, wherein each of the plurality of vertically positioned catalytic beds comprises an alkali metal-promoted catalyst;
passing the thermal oxidizer effluent through the oxidative catalytic converter to contact the thermal oxidizer effluent with the alkali metal-promoted catalyst, thereby oxidizing at least a portion of the SO₂ to sulfur trioxide (SO₃) with the O₂ from the thermal oxidizer effluent and producing a spent catalyst and an oxidized gas stream leaving the oxidative catalytic converter;
cooling the oxidized gas stream in a waste heat recovery system to generate a cooled exit stream;
introducing the cooled exit stream into a quench tower comprising one or more packing zones;
contacting the cooled exit stream with a diluted aqueous acid quench stream in the quench tower to dissolve the SO₃ and the rest of the portion of the SO₂ in the diluted aqueous acid quench stream, thereby generating sulfurous acid (H₂SO₃), hydrated sulfur dioxide, and sulfuric acid (H₂SO₄); and
oxidizing the H₂SO₃ and the hydrated sulfur dioxide with the O₂ from the thermal oxidizer effluent in the one or more packing zones, thereby generating a diluted aqueous acid product stream comprising H₂SO₄ leaving the quench tower.

2. The method of claim 1, comprising combusting a fluid composition in a thermal oxidizer to generate the thermal oxidizer effluent comprising the O₂ and SO₂, wherein the fluid composition comprises a combustible gas, an oxygen-containing oxidant gas, and a tail gas comprising one or more sulfur-containing compounds.

3. The method of claim 2, wherein the oxygen-containing oxidant gas comprises a number of moles of oxygen exceeding the number of moles of oxygen required to fully combust the sulfur-containing compounds and the combustible gas.

4. The method of claim 2, wherein:
the one or more sulfur-containing compounds are selected from the group consisting of hydrogen sulfide (H₂S), SO₂, sulfur vapor, carbonyl sulfide (COS), and carbon disulfide (CS₂); and
the combustible gas is selected from the group consisting of methane, propane, butane, ethylene, propylene, acetylene, hydrogen, natural gas, ethane, methanol, ethanol, and mixtures thereof.

5. The method of claim 1, wherein the O₂ is present in the thermal oxidizer effluent in an amount of about 2 to about 30 vol. % by a total volume of the thermal oxidizer effluent.

6. The method of claim 1, wherein the alkali metal-promoted catalyst is an alkali metal-promoted vanadium catalyst, and wherein the alkali metal is selected from the group consisting of cesium, potassium, rubidium, lithium, sodium, and mixtures thereof.

7. The method of claim 1, wherein the alkali metal-promoted catalyst is regenerated in-situ in the oxidative catalytic converter by reacting the spent catalyst with the O₂ from the thermal oxidizer effluent during the passing.

8. The method of claim 1, wherein the H₂SO₄ is present in the diluted aqueous acid product stream in an amount of about 0.1 and about 10 wt. % by a total weight of the diluted aqueous acid product stream.

9. The method of claim 1, wherein the quench tower is in the form of a cylindrical reactor comprising an upper section, a lower section, and two or more packing zones evenly distributed within the upper section and lower section of the quench tower, wherein the two or more packing zones are separated by a perforated plate configured to allow gas molecules to pass through and redistribute water within packing zones of the lower section.

10. The method of claim 9, wherein the upper section and the lower section are connected via the perforated plate.

11. The method of claim 1, further comprising:
cooling the diluted aqueous acid product stream in a cooler to generate a cooled diluted aqueous acid product stream comprising H₂SO₄; and
introducing the cooled diluted aqueous acid product stream comprising H₂SO₄ into a buffer tank, wherein the buffer tank is in fluid communication with the quench tower via the diluted aqueous acid quench stream, and wherein the buffer tank is in fluid communication with a water treatment unit via a diluted aqueous acid buffer stream.

12. The method of claim 11, wherein the water treatment unit generates a permeate that is substantially water and a H₂SO₄-containing retentate having a H₂SO₄ concentration of about 3 to about 98 wt. % of the H₂SO₄-containing retentate.

13. The method of claim 12, further comprising introducing the permeate of the water treatment unit to the buffer tank.

14. A system for sulfur dioxide (SO₂) removal, the system comprising:
a thermal oxidizer configured to receive and combust a fluid composition comprising a combustible gas, an oxygen (O₂)-containing oxidant gas, and a tail gas to generate a thermal oxidizer effluent comprising sulfur dioxide (SO₂) and O₂;
an oxidative catalytic converter coupled to the thermal oxidizer and configured to oxidize at least a portion of the SO₂ to SO₃ with the O₂ from the thermal oxidizer effluent and produce a spent catalyst and an oxidized gas stream leaving the oxidative catalytic converter;
a waste heat recovery system coupled to the oxidative catalytic converter and configured to cool the oxidized gas stream to generate a cooled exit stream;
a quench tower comprising one or more packing zones coupled to the waste heat recovery system and configured to receive the cooled exit stream, and contact the cooled exit stream with a diluted aqueous acid quench stream to dissolve the SO₃ and the rest portion of the SO₂ in the diluted aqueous acid quench stream to generate sulfurous acid (H₂SO₃), hydrated sulfur dioxide, and sulfuric acid (H₂SO₄), and to oxidize the H₂SO₃ and the hydrated sulfur dioxide with the O₂ from the thermal oxidizer effluent to generate a diluted aqueous acid product stream comprising H₂SO₄ leaving the quench tower;
a cooler coupled to the quench tower and configured to receive and cool the diluted aqueous acid product stream to generate a cooled diluted aqueous acid product stream;
a first buffer tank coupled to the cooler and configured to receive the cooled diluted aqueous acid product stream and generate a diluted aqueous acid buffer stream comprising H₂SO₄; and
a water treatment unit coupled to the buffer tank and configured to receive the diluted aqueous acid buffer stream comprising H₂SO₄ and generate a permeate and a H₂SO₄-containing retentate.

15. The system of claim 14, wherein the buffer tank further comprises a vent, wherein the vent is connected to a clean water stream or a water trap.

16. The system of claim 14, wherein the water treatment unit is selected from the group consisting of a reverse osmosis (RO) membrane unit, an electrodialysis unit, a distillation unit, and combinations thereof.

17. The system of claim 16, wherein the water treatment unit is a RO membrane unit, and wherein the RO membrane unit yields a permeate that is substantially water and a retentate comprising about 3 to about 98 wt. % of H₂SO₄.

18. The system of claim 14, wherein the thermal oxidizer effluent is introduced into the oxidative catalytic converter at a temperature of about 400° C.

19. The system of claim 14, wherein the waste heat recovery system is configured to cool the oxidized gas stream to a temperature of about 105° C.

20. The system of claim 14, wherein the diluted aqueous acid quench stream is introduced into the quench tower at a temperature of about 40 to about 65° C.

21. The system of claim 14, wherein the diluted aqueous acid product stream comprises about 0.1 to about 10 wt. % of H₂SO₄.

22. The system of claim 14, wherein the quench tower is in the form of a cylindrical reactor comprising an upper section, a lower section, and two or more packing zones evenly distributed in the upper section and lower section of the quench tower, wherein the two or more packing zones are separated by a perforated plate configured to allow gas molecules to pass through and redistribute water within packing zones of the lower section.

23. The system of claim 22, further comprising:
a second buffer tank coupled between the quench tower and the water treatment unit, wherein the second buffer tank is configured to bypass the water treatment unit and receive the diluted aqueous acid buffer stream from the first buffer tank or receive the permeate from the water treatment unit, and configured to flow the diluted aqueous acid buffer stream to the upper section of the quench tower.

24. The system of claim 14, wherein the quench tower is in the form of a cylindrical reactor comprising:
an upper section, a lower section, and two or more packing zones evenly distributed in the upper section and lower section of the quench tower, wherein the two or more packing zones are separated by a plate, wherein the plate comprises a plurality of bubble caps, and is configured to allow gas molecules to pass through the plate and collect recovered water, resulting in the formation of a fresh water stream; and
a pH monitor configured to monitor the pH of the fresh water stream.

25. The system of claim 24, further comprising:
a second buffer tank coupled between the quench tower, the water treatment unit, and the first buffer bank, wherein the second buffer tank is configured to bypass the water treatment unit and receive the diluted aqueous acid buffer stream from the first buffer tank, or receive the permeate from the water treatment unit, configured to flow the diluted aqueous acid buffer stream to the upper section of the quench tower, and configured to receive the fresh water stream from the quench tower via a valve when the pH of the recovered water is below 0.5.
